(19) United States
(12) Patent Application Publication
(10) Pub. No.: US 2012/0128446 A1
(43) Pub. Date: May 24, 2012

(54) DEVICE FOR A TIGHTENED CONNECTION OF STRUCTURAL PARTS ARRANGED ONE AFTER ANOTHER WITH DISTANCE

(75) Inventor: Gerald BAUMBACH, Tabarz (DE)

(73) Assignee: EJOT GMBH & CO. KG, Bad Laasphe (DE)

(21) Appl. No.: 13/299,598

(22) Filed: Nov. 18, 2011

(30) Foreign Application Priority Data
Nov. 19, 2010 (DE) 10 2010 051 923.5

(51) Int. Cl. F16B 25/02

(52) U.S. Cl. 411/387.1

(57) ABSTRACT

Device for tightened connection of structural parts positioned with distance between each other having a self-cutting screw penetrating an upper and a following lower structural part, and a screw thread engaging the structural parts. The upper structural part is prolonged by longitudinal rails received in recesses in the lower structural part, and an advance bolt is put in advance to the screw. The advance bolt stays in its advance position upon screwing back the screw thereby that a connection element activated by the displaced advance bolt causes a connection between the lower structural part and the longitudinal rails. Thereby both structural parts are kept at the existing distance.

The invention relates to a device for tightened connection of structural parts positioned with distance between each other having a self-cutting screw penetrating an upper and a following lower structural part, and a screw thread engaging the structural parts.

When connecting two structural parts, for example two plates arranged with a distance from each other, there is frequently the problem to temporarily disconnect and thereafter re-establish this connection for any repair works, wherein it has to be assured that the distance between the two structural parts defined initially by the connection is maintained in the reconnection thereof. For this purpose, one can provide distance members which are clamped upon the connection of the two parts between them and which are again inserted upon the reconnection of both parts between them. Initially, the problem is resulting wherefrom that the distance to be kept between both structural parts is ensued only upon mounting thereof.

For example, in case a headlight of an automobile is to be fixed to an automobile body, a predefined distance has to be kept, therein, frequently between the respective body parts and lamp socket, which distance is, however, frequently varying from automobile to automobile also of the same type which is to be attributed to respective, unavoidable inaccuracies of the respective locations of the vehicle body (tolerances). In such cases, different distance members have to be at hand which are to be inserted respectively adapted to the respective automobile which is a substantial burden in particular for repair works, since, in such cases, a larger number of distance members would have to be at disposal in order to be correspondingly inserted according to the respective automobile.

The invention is based on the objective to provide a device for a tightened connection of structural parts arranged one after another with distance by means of a self-cutting screw penetrating an upper and a following lower structural part, and with a screw thread engaging the structural part, wherein, upon making the connection by means of the screw penetrating both structural parts, the respective distance in the respective application is automatically set and maintained such that the removal and reinstallation of both structural parts by again screwing in the screw, the correct distance between both structural parts is automatically restored without adding any distance members.

This problem is solved thereby that the upper structural part is prolonged by longitudinal rails received in recesses of the lower structural part, and that an advance bolt is put in front of the screw which bolt the screw is displacing upon being screwed in, and which bolt keeps its displaced deposition upon screwing back the screw thereby that a connection element activated by the displaced advance bolt, causes a connection between the lower structural part and the longitudinal rails such that both structural parts are fixed at the existing distance.

Because of the longitudinal rails starting from the upper structural part and extending into the lower structural part, an overlapping area of portions of the two structural parts is resulting into which the advance bolt is pushed in upon screwing in of the screw and remains in the reached position of the completed connection between both structural parts, whereby, the means of its position in the overlapping area of the portions of the two structural parts, they are fixed by means of the connection element which engages and, thereby, fixes both structural parts without unscrewing of the screw causing any influences thereon. Thereby, the distance of both structural parts coming about upon screwing in of the screw, is fixed such that any operations of the structural parts can be made without it being possible that the distance of both structural parts, as defined by the influence of advance bolt, is changed.

For the operation of the advance bolt, one designs it in an advantageous way such that the advance bolt is displaced by the screw upon screwing in thereof by means of an engagement part in the front side and a receiving pull-in part at the advance bolt, wherein the connection element which makes a connection between the lower structural part and the longitudinal rails, fixes both structural parts at the existing distance. Therein, a friction surface can serve as a connection element which surface becomes active between the longitudinal rails and the lower structural part by means of adjacent teeth and causes the mutual engagement of the longitudinal rails and the lower structural part upon the screw being screwed in and the advance bolt being correspondingly displaced. In case the screw is unscrewed, the frictional surface together with the teeth having penetrated the respective counter part, ensures that both structural parts can not be actually displaced with respect to each other also in case of an unscrewed screw, whereby the initially defined distance is maintained also with an unscrewed screw. Therein, it is possible to provide the teeth of the friction surface either on the outer surface of the advance bolt, or it is also possible to design the friction surface such that the teeth are provided on the bottom of the recesses supporting the longitudinal rails where they then become active with respect to the lower structural part.

A thread can serve as a connection element which thread has the same pitch like the thread of the screw such that, upon screwing in the screw and advancing of the advance bolt, a continues thread is cut into both structural parts which thread extends across both structural parts. In the area of overlapping the portions of both structural parts the advance bolt is seated, with its threads, in both components and keeps them at their distance such that the screw may be unscrewed from both structural parts without it being possible that they are displaced with respect to each other in longitudinal direction since the thread of the advance bolt engages into both portions of both structural parts and fixes them at their distance position.

Another possibility of design of the surface of the advance bolt consists in giving it, as connection element, a friction surface roughened by adjacent tooth which, upon screwed in the screw and correspondingly displacing the advance bolt, engage the lower structural part as well as the longitudinal rails. In this way, similar to the above described thread arrangement on the advance bolt, it is achieved that the respective portions of both structural parts, are kept, by means of the friction surface, at the distance in which they are located upon screwing in the screw.

A further possibility of the design of the connection element consists in forming it by an adhesive layer surrounding the surface of the advance bolt which layer connects the lower structural part and the longitudinal rails with the screw being screwed in. In this case the hardened adhesive layer takes over the maintenance of the distance instead of the above described thread. Therein, an adhesive layer with an adhesive is advantageously used which is softened by friction upon screwing in the advance bolt.

For pulling in the advance bolt upon screwing in the screw, the engagement position of the front side of the screw and the front side of the advance bolt advanced by the screw is given such a shape that the pulling in of the advance bolt upon screwing in the screw is ensured thereby. Upon unscrewing the screw, the connection of the screw and the advance bolt is automatically disconnected. A possibility for the design of the pull-in feature consists in that the engagement part is formed like a drill tip and the receiving part is formed as a recess fitting thereto whereby, upon screwing action, the engagement part and the pulling in part are locked to each other, and, in this way, the advance bolt is correspondingly pulled in upon screwing in the screw.

Further advantages, features and potential applications of the present invention may be gathered from the description which follows, in conjunction with the embodiments illustrated in the drawings.

Throughout the description, the claims and the drawings, those terms and associated reference signs will be used as are notable from the enclosed list of reference signs. In the drawings

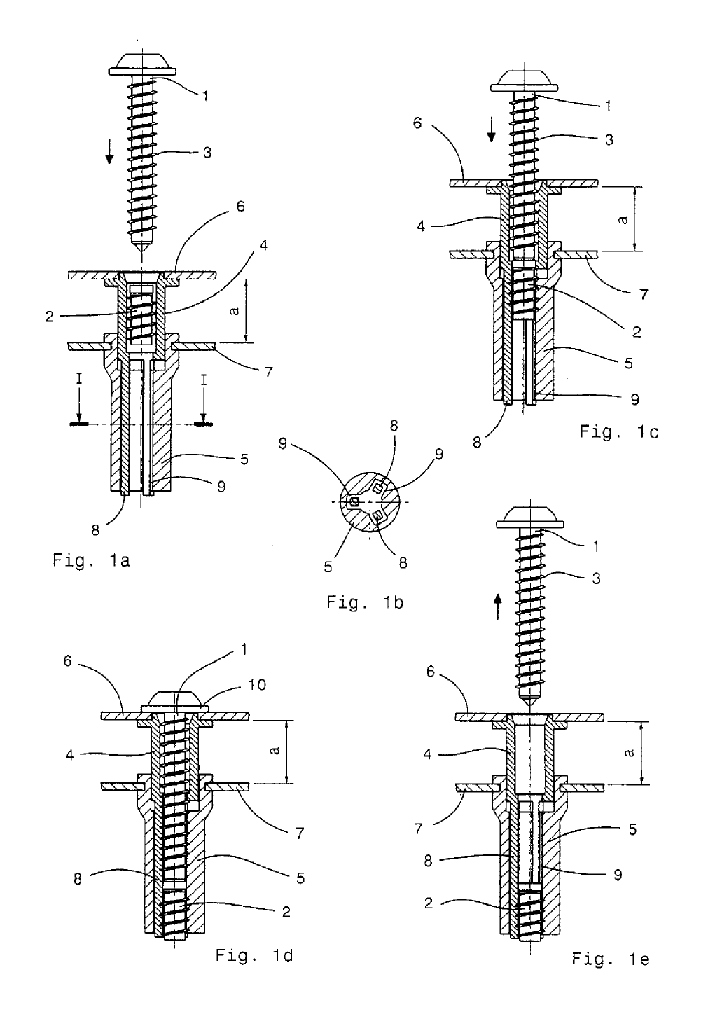

FIGS. 1a-e show two structural parts in an untightened and a tightened state with respective sectional views while using an advance bolt with thread;

FIG. 2 shows two structural parts connected to each other having a connection element formed by a friction surface on the advance bolt;

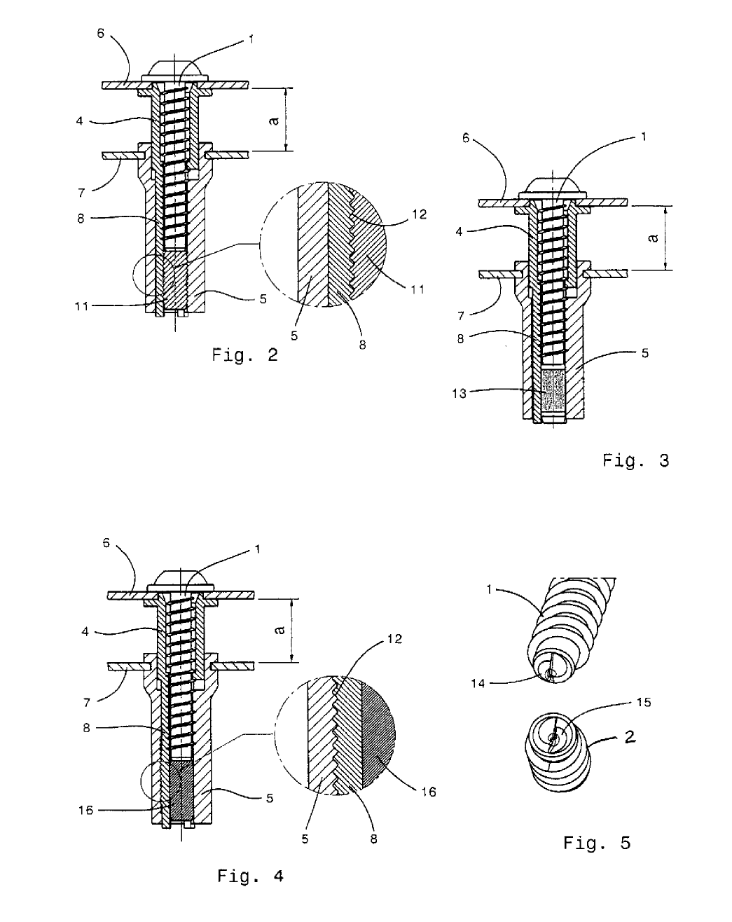

FIG. 3 shows two structural parts connected to each other with a connection element formed by an adhesive layer on the advance bolt;

FIG. 4 shows two structural parts connected to each other having a friction surface between the bottom of the recesses supporting the longitudinal rails and the longitudinal rails inserted into the recesses, and

FIG. 5 shows the engagement parts of the front side of the screw and the corresponding pull-in part on the advance bolt for the fitting reception of the engagement part.

In FIGS. 1a to 1e, the embodiment is shown in which the screw 1 as well as the advance bolt 2 are provided with a self-cutting thread 3 which extends, with the same pitch, across the screw 1 as well as the advance bolt 2 in such a way that, in the case of the advancement of the advance bolt 2 by means of the screw 1, a continuous thread is resulting, i.e. that, in case of the displacement situation according to FIG. 1d, the thread 3 on the screw 1 and on the advance bolt 2 appear as stepless, continuous thread.

The upper structural part 4 and the lower structural part 5 are kept fixed to each other by means of the screw 1, i.e. in the distance between the plates 6 and 7 designated as a, which plates are respectively supported by the upper structural part 4 and the lower structural part 5 respectively. The distance a has to be kept between these two plates 6 and 7 also in case when, out of any reason, the screw 1 is screwed out from the connection shown in FIG. 1a, as is shown in FIG. 1e. In FIG. 1e, the screw 1 is drawn up as completely screwed out of the combination of the two structural parts 4 and 5, so that the screw 1 can not have any effect anymore on the connection of the structural part 4 and the structural part 5. This connection is ensured by the screwed in advance bolt 2 (see FIG. 1e).

As can be seen from FIG. 1a, the structural part 4 is prolonged into the lower part 5 by means of longitudinal rails 8, and the lower structural part 5 is provided with corresponding recesses 9 as they are shown in the sectional view of FIG. 1b, which shows the view along the sectional line I-I in FIG. 1a.

As can be seen from FIGS. 1a and 1c, the prolongation bolt 2 is pulled in by the screw, in particular by the front side of the screw 1 and pulled in (the slaving effect will be mentioned in detail below) wherein FIG. 1c shows the situation in which the screw 1 already has displaced the advance bolt 2 into the area of the lower structural part 5.

In FIG. 1d, the final position of the screw 1 is shown which, therein, presses with its shoulder 10 onto the plate 6, and which fixes, with its thread 3, the lower structural part 5 at the given distance. In this position, the advance bolt 2 is completely advanced into the area of the lower structural part.

If, out of any reason, for example because of a repair, the screw 1 is now screwed out of the compound of the upper structural part 4 and the lower structural part 5, as is shown in FIG. 1e, the advance bolt 2 remains in the area of lower structural part 5 which bolt engaged with its thread the areas of the lower structural part 5 surrounding the advance bolt 2, and it has simultaneously penetrated the longitudinal rails 8 extending out from the upper structural part 4 so that a connection is resulting by means of the inserted advance bolt between the lower structural part 5 and the longitudinal rails 8 which, as parts of the upper structural part 4, are fixing its position with respect to the lower structural part 5. It is ensured thereby that the distance a to be kept between the plates 6 and 7 or the tightened connection of the upper structural part 4 and the lower structural part 5 is maintained by means of the screwed in advance bolt 2 which remains in its position also upon screw 1 being screwed out, as is shown in FIG. 1e.

In FIG. 2, another possibility of the design of the connection element is shown where, in the doted circle, an enlarged representation of the connection element is shown which consists here out of a friction surface formed by teeth 12 which surface is applied to the surface of the advance bolt 11. The friction surface formed by teeth 12 constitutes a slaving connection between the advance bolt 11 and the longitudinal rail 8 whereby it is ensured that the advance bolt 11 is fixed; also upon the screw 1 being unscrewed, on its position and that it penetrates, with its teeth, into the longitudinal rails as well as into the area of the lower structural part 5 located next to the longitudinal rails, and, thereby, fixes the advance bolt 11 in the position reached, independently from the unscrewing of the screw 1.

In FIG. 3, a further possibility for the design of the connection element is shown which consists, here; out of an adhesive layer 12 applied the advance bolt. The adhesive layer fixes the advance bolt within the respective area of the longitudinal rails 8 and the lower structural part such that the advance bolt is, at the one hand, safely kept at the respective position and, on the other hand, provides the mutual connection of the lower structural part 5 and the longitudinal rails 8 and, thereby, on the upper structural part.

In FIG. 4, a modification of the design according to FIG. 2 is shown. According to FIG. 4, there is a friction surface on the outside of the longitudinal rails 8 which engage the bottom of the recesses receiving the longitudinal rails 8 in the lower structural part 5, and, thereby, lock the lower and upper structural parts against displacement by penetrated teeth. The pressure in a radially outward direction required therefore, is exerted by the otherwise smooth advance bolt 16. In the surface surrounded by the circle drawn up in doted lines, the respective friction surface with the teeth 12 is clearly shown.

FIG. 5 shows a shape of an engagement part 14 and a pull-in part 15. The engagement part 14 is, among others, for use in the embodiment according to FIG. 1 shaped like a drill tip which penetrates into the pull-in part 15 on the advance bolt 2. Because of its shape, it is possible, that the connection formed by the engagement part 14 and the pull-in part 15 is automatically disconnected upon screwing back the screw 1 so that the screwing back of the screw 1 does not influence the position of the advance bolt 2.

It is to be understood that the above description is intended to be illustrative and not restrictive. Many embodiments will be apparent to those skilled in the art upon reviewing the above description. The scope of the invention should, therefore, be determined not as reference to the above description, but should instead be determined with reference to the appended claims along with the full scope of equivalence to which such claims are entitled.

### LIST OF REFERENCE SIGNS

1 screw
2 advance bolt
3 thread
4 upper structural part
5 lower structural part
6 plate
7 plate
8 longitudinal rails
9 recesses
10 shoulder
11 advance bolt
12 friction surface
13 adhesive layer
14 drill tip
15 receiving part
16 advance bolt

1. Device for tightened connection of structural parts positioned with distance between each other having
a self-cutting screw penetrating an upper and a following lower structural part, and a screw thread engaging the structural parts; wherein
the upper structural part is prolonged by longitudinal rails received in recesses in the lower structural part; and wherein
an advance bolt is put in advance to the screw which bolt the screw is displacing upon screwing in and which is held, upon screwing back on the screw, in its advanced position thereby that a connection element activated by the displaced advance bolt causes a connection between the lower structural part and the longitudinal rails, such that both structural parts are kept at the existing distance.

2. Device according to claim 1, wherein the advance bolt is displaced by the screw upon screwing in thereof by means of an engagement part at its front side and a pull-in part on the advance bolt, whereby the connection element forms a connection between the lower structural part and the longitudinal rails which fixes both structural parts in the existing distance.

3. Device according to claim 2, wherein the connection element is formed by a thread on the advance bolt which has the same pitch as the thread of the screw, and that the thread engages the lower structural part as well as the longitudinal rails such that both structural parts are fixed at the existing distance.

4. Device according to claim 1, wherein the connection element consists out of a friction surface surrounding the advance bolt and roughened by adjacent teeth, which surface engages the lower structural part as well as the longitudinal rails upon screwed in screw and correspondingly displaced advance bolt.

5. Device according to claim 1, wherein the connection element is formed by an adhesive layer surrounding the surface of the advance bolt which layer connects the lower structural part and the longitudinal rails upon the screw being screwed in.

6. Device according to claim 5, wherein the adhesive layer comprises a hot-melt adhesive which is softened by friction upon screwing in the advance bolt.

7. Device according to claim 2, wherein the engagement part is formed like a drill tip and the pull-in part is formed like a recess fitting thereto.

8. Device according to claim 1, wherein, in between the longitudinal rails and the lower structural part, a friction surface roughened by adjacent teeth is provided which surface causes a mutual penetration of the longitudinal rails and the lower structural part upon the screw being screwed in and upon corresponding displacement of the advance bolt.

9. Device according to claim 8, wherein the teeth are provided on the outer surface of the advance bolt.

10. Device according to claim 8, wherein the teeth are provided on the bottom of the recesses supporting the longitudinal rails.
